(19) United States
(12) Patent Application Publication
(10) Pub. No.: US 2013/0280939 A1
(43) Pub. Date: Oct. 24, 2013

(54) SURFACE CONTACT CARD HOLDER FOR ELECTRONIC DEVICE

(71) Applicants: SHENZHEN FUTAIHONG PRECISION INDUSTRY, Shenzhen City (CN); FIH (HONG KONG) LIMITED, Kowloon (HK)

(72) Inventors: CHIH-WEI CHANG, New Taipei (TW); GUO-LIANG WAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/671,520

(22) Filed: Nov. 7, 2012

(30) Foreign Application Priority Data
Apr. 23, 2012 (CN) 201210119750.1

(51) Int. Cl. H01R 13/62

(52) U.S. Cl. 439/325

(57) ABSTRACT

A surface contact card holder includes a seat. The seat includes two positioning portions facing with each other. A plurality of tabs extend from one side of each positioning portion, and a plurality of support sheets extend from another side of each positioning portion, the tabs and the support sheets together defining a receiving space for receiving a surface contact card.

### BACKGROUND

1. Technical Field

The present disclosure generally relates to card use in electronic devices, and particularly to a surface contact card holder for an electronic device.

2. Description of related art

With the development of wireless communication and information processing technologies, portable electronic devices such as mobile phones are widely used. Surface contact cards having special circuits are used in portable electronic devices to enhance or add to the functions of the portable electronic devices. For example, a subscriber identity module (SIM) card can be placed in a mobile phone to dedicate the mobile phone's functions to the SIM card owner. By changing SIM cards, a single mobile phone can be used by many different SIM card owners as a personal phone.

However, conventional surface contact card holder includes a tray assembled to the mobile phone. Since the internal space of the mobile phone is very limited, the tray has to occupy the internal space of the mobile phone. Additionally, the tray also needs to be assembled. Thus, the assembly process is complicated.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the surface contact card holder. Moreover, in the drawings, like reference numerals designate corresponding parts throughout the several views.

FIG. 1 is an isometric view of a surface contact card holder in accordance with an exemplary embodiment.

FIG. 2 is an enlarge view of the surface contact card holder from another aspect.

FIG. 3 is an assembling view of a surface contact card on the surface contact card holder.

FIG. 4 is an assembled isometric view of the surface contact card holder showing the surface contact card in position on the surface contact card holder.

### DETAILED DESCRIPTION

The disclosed surface contact card holder can seat surface contact cards such as SIM cards, compact flash cards (CFs) and multimedia cards (MMCs), for example. The disclosed electronic device in the exemplary embodiment is a mobile phone, and can alternatively be a PDA, camera, recorder, or other devices, while remaining well within the scope of the disclosure.

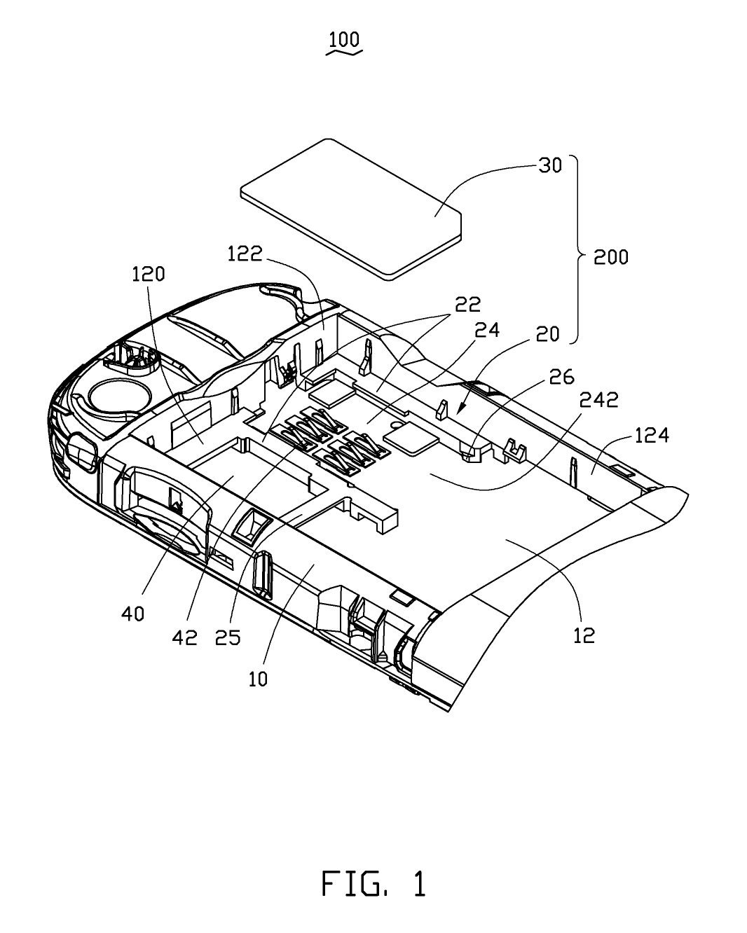

FIG. 1 shows a surface contact card holder 200 mounted on an electronic device 100. The electronic device 100 includes a housing 10 and a printed circuit board 40. The surface contact card holder 200 includes a seat 20 integrally formed on the housing 10 to receive a surface contact card 30.

The housing 10 defines a battery receiving cavity 12 for receiving a battery. The battery receiving cavity 12 is defined by a bottom portion 120, two first sidewalls 122, and two opposite second sidewalls 124.

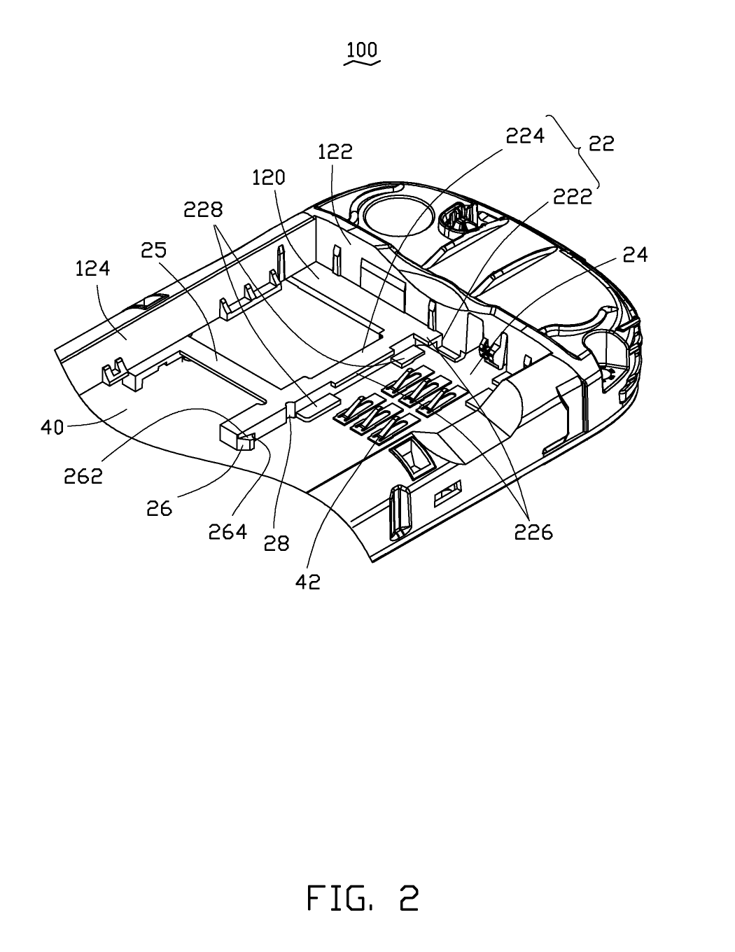

Referring to FIG. 2, the seat 20 is formed on the bottom portion 120 in the battery receiving cavity 12. The seat 20 includes two positioning portions 22 facing with each other. Each positioning portion 22 is substantially L-shape and includes a first beam 222 and a second beam 224. The first beam 222 extends from one first sidewall 122, and the second beam 224 is perpendicularly connected to the first beam 222. A plurality of tabs 226 extend from one side of the first beam 222 and the second beam 224. A thickness of the tabs 226 is less than the first beam 222 and the second beam 224. A plurality of support sheets 228 extend from another side of the second beam 224. The tabs 226 and the support sheets 228 together define a receiving space 24, for receiving the surface contact card 30. An entrance 242 is defined at one end of the receiving space 24. One positioning portions 22 is adjacent to one second sidewall 124. In order to stably secure the other positioning portion 22, a reinforcing beam 25 extends from the other second sidewall 124, and is connected to the second beam 224.

Each second beam 224 has a guiding block 26 at a distal end. The guiding block 26 has a slope 262, at a top surface, and an arcuate latching end 264. The slope 262 is configured for guiding the surface contact card 30 to slide in the receiving space 24. The arcuate latching end 264 is used for latching one end of the surface contact card 30.

The second beam 224, of the positioning portion 22 connected to the reinforcing beam 25, defines a notch 28 for allowing the second beam 224 to have enough elasticity to stretch under an outer force.

The printed circuit board 40 is positioned at another side of the housing 10. A plurality of contacts 42 are located on the printed circuit board 40, and they are received in the receiving space 24, for electronically connecting the surface contact card 30.

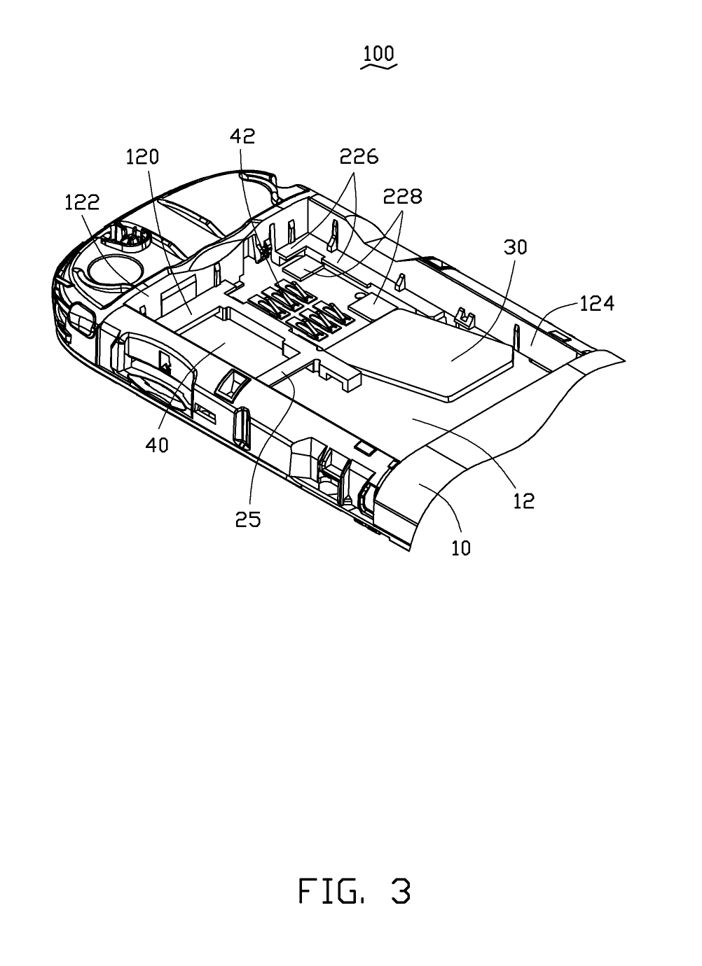

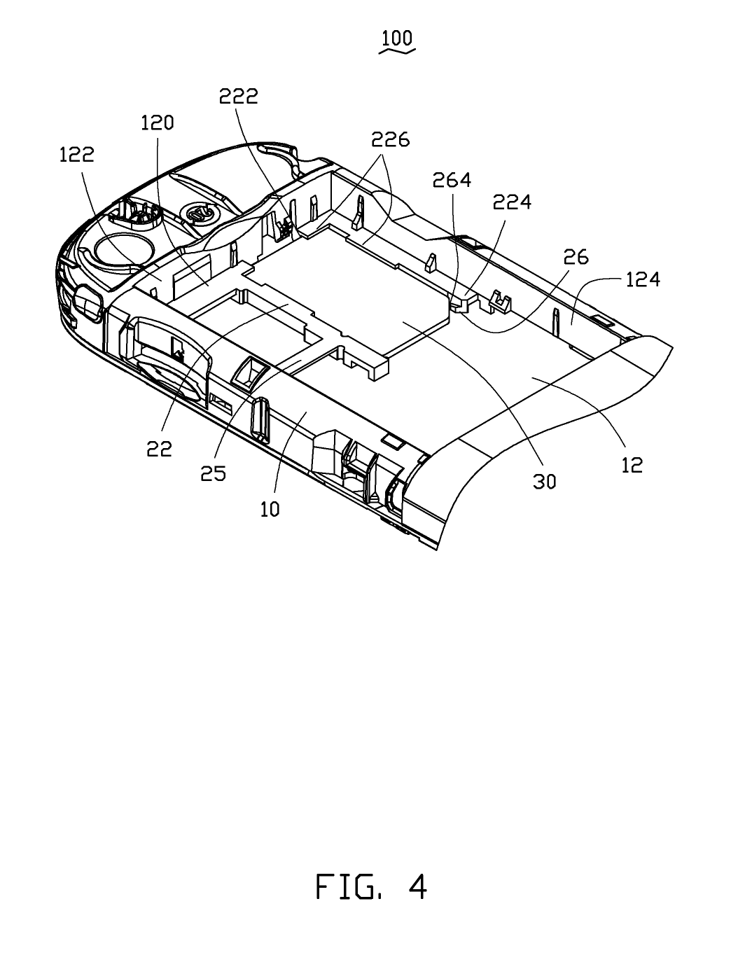

In use, referring to FIGS. 3 and 4, the surface contact card 30 is taken here as an exemplary application for the purposes of describing details of the surface contact holder 200. The surface contact card 30 is inserted into the receiving space 24 from the entrance 242, and is positioned on the slope 262 of the guiding block 26 and the support sheets 228. An outer force is applied on the surface contact card 30 to allow the surface contact card 30 to slide in the receiving space 24, along the slope 262, until one end of the surface contact card 30 resists against the first beams 222. Another end of the surface contact card 30 slides into the arcuate latching end 264. Thus, the surface contact card 30 is thereby held steadily in the housing 10. Since the width of the receiving space 24 is less than that of the surface contact card 30, when the surface contact card 30 is inserted, the positioning portion 22, connected to the reinforcing beam 25, can stretch out of the receiving space 24. After the surface contact card 30 is completely received in the receiving space 24, the positioning portion 22, connected to the reinforcing beam 25, automatically resumes and tightly latches the surface contact card 30.

To remove the surface contact card 30, an outside force is applied to the surface contact card 30 toward a direction of the entrance 242. The surface contact card 30 slides on the slopes 262, and the surface contact card 30 is easily removed from the housing 10.

As described above, the exemplary embodiment provides a surface contact card holder for portable electronic devices, such as mobile phones. The surface contact card holder can be easily opened and is more user-friendly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A surface contact card holder, comprising:
a seat comprising two positioning portions facing with each other;
a plurality of tabs extending from one side of each of the two positioning portions, and a plurality of support sheets extending from another side of each of the two positioning portions, and the plurality of tabs and the plurality of support sheets together defining a receiving space for receiving a surface contact card.

2. The surface contact card holder as claimed in claim 1, wherein each of the two positioning portions comprises a first beam and a second beam, and the second beam is perpendicularly connected to the first beam.

3. The surface contact card holder as claimed in claim 2, wherein the tabs extend from one side of the first beam and the second beam, the support sheets extend from another side of the second beam, and a thickness of the tabs is less than the first beam and the second beam.

4. The surface contact card holder as claimed in claim 2, wherein a reinforcing beam is connected to the second beam.

5. The surface contact card holder as claimed in claim 2, wherein each second beam comprises a guiding block at a distal end, the guiding block comprise a slope and an arcuate latching end, and the arcuate latching end is configured for latching one end of the surface contact card.

6. A portable electronic device comprising:
a housing defining a battery receiving cavity;
a seat located in the battery receiving cavity, the seat comprising two positioning portions facing with each other;
a plurality of tabs extending from one side of each of the two positioning portions, and a plurality of support sheets extending from another side of each of the two positioning portions, the plurality of tabs and the plurality of support sheets together defining a receiving space; and
a guiding block formed at a distal end of each of the two positioning portions.

7. The portable electronic device as claimed in claim 6, wherein the battery receiving cavity is defined by a bottom portion, two opposite first sidewalls and two opposite second sidewalls, and the seat is integrally formed on the bottom portion in the battery receiving cavity.

8. The portable electronic device as claimed in claim 7, wherein each positioning portion comprises a first beam and a second beam, the first beam extends from one of the two first sidewalls, and the second beam is perpendicularly connected to the first beam.

9. The portable electronic device as claimed in claim 8, wherein the tabs extend from one side of the first beam and the second beam, the support sheets extend from another side of the second beam, and a thickness of the tabs is less than the first beam and the second beam.

10. The portable electronic device as claimed in claim 8, wherein each second beam comprises a guiding block at a distal end, the guiding block comprise a slope and an arcuate latching end, and the arcuate latching end is configured for latching one end of the surface contact card.
